(19) United States
(12) Patent Application Publication
(10) Pub. No.: US 2024/0379273 A1
(43) Pub. Date: Nov. 14, 2024

(54) Submerged Ferrite Flowing Fluid Cooled Transformer

(71) Applicant: Radyne Corporation, Milwaukee, WI (US)

(72) Inventors: John Justin MORTIMER, Waukesha, WI (US); Roberto Bernardo Benedicto OVANDO, Franksville, WI (US); Robert L. WEBER, Muskego, WI (US)

(21) Appl. No.: 18/655,394

(22) Filed: May 6, 2024

Related U.S. Application Data
(60) Provisional application No. 63/464,961, filed on May 9, 2023.

(51) Int. Cl. H01F 27/10; H01F 27/02; H01F 27/24; H01F 27/32

(52) U.S. Cl. CPC H01F 27/105; H01F 27/025; H01F 27/24; H01F 27/32

(57) ABSTRACT

A transformer assembly is formed from a primary winding wound about a toroidal or other annularly shaped magnetic core. A secondary winding passes through a center of the magnetic core and about an exterior of the magnetic core. The transformer assembly is disposed within a sealed enclosure into which fluid is introduced to directly contact the magnetic core before exiting through an outlet, submerging the magnetic core, the primary winding, and the secondary winding in flowing fluid. The primary winding may be disposed within a flexible tubing through which fluid flows, or alternatively, the primary winding may be cooled via contact with the cooling fluid flowing through the sealed enclosure. The secondary winding may be either internally cooled via cooling fluid flowing therethrough, or externally cooled via the cooling fluid flowing through the sealed enclosure. In some embodiments, a separate coil cooling circuit is defined external to the sealed enclosure.

### REFERENCE TO RELATED APPLICATIONS

The application claims priority to U.S. Provisional Application No. 63/464,961 filed May 9, 2023, hereby incorporated by reference in its entirety.

### FIELD OF THE INVENTION

The present invention relates to a submerged ferrite flowing fluid cooled transformer whose heat transfer capabilities and design enhances the practical power output levels while maintaining a reduced form factor and reducing the weight of conventional fluid cooled transformers.

### BACKGROUND OF THE INVENTION

In the ever-competitive battle to deliver lightweight transformers that are easily articulated by humans or by robots, one eventually comes to the point where there are tradeoffs between magnetic material weight, transformer volume, power output and heat generation. Higher permeability materials deliver more power by volume and thus are more compact, making them easier to package in ways that facilitate human and robotic handling.

However, higher permeability materials inevitably generate more heat than lower permeability materials. This demands special design attention to remove the heat for the device to retain its permeability during operation. The efficiency of heat removal ends up driving the duty cycle of operation and maximum power that such a device can transmit.

Typical means by which magnetic structures are cooled generally include placing water cooled copper, or other mechanical heat sinks in contact with the magnetic material. Such structures are problematic due to the primary turns on the transformer which also generate heat while in operation. Additionally, even at low frequencies these structures are susceptible to induction heating due to the fields generated by the primary winding currents. Alternatively, transformers may be oil filled to aid in magnetic structure cooling, however filling the volume of the transformer with oil adds significant weight.

One object of the present invention is to provide a transformer assembly having fluid-cooled primary winding and a forced fluid-cooled magnetic core producing improved power performance due to more efficient cooling and lighter weight over conventional transformer assemblies known in the art.

### BRIEF SUMMARY OF THE INVENTION

In one aspect the present invention is a transformer assembly formed from a fluid-cooled primary winding wound about a magnetic core, wherein the primary winding is disposed within a flexible tubing through which fluid flows. The transformer assembly is further disposed within a sealed enclosure into which fluid is introduced to directly contact the magnetic core, effectively submerging the magnetic core in flowing cooling fluid before being transmitted to an induction coil via a hollow secondary winding. After cooling the induction coil, the cooling fluid returns through a return line of the secondary winding and exits the sealed enclosure through an enclosure outlet.

In another aspect, the present invention is a transformer assembly formed from a primary winding wound about a magnetic core disposed within a sealed enclosure and a secondary winding passing through a central aperture of the magnetic core and about an exterior of the magnetic core, wherein cooling fluid flows into the sealed enclosure to directly contact the magnetic core and the primary winding effectively submerging the magnetic core, the primary winding, and the secondary winding in flowing cooling fluid, whereupon the cooling fluid exits the sealed enclosure via an enclosure outlet, defining a transformer cooling circuit. An independent coil cooling circuit is defined between a coil inlet and a coil outlet disposed on a connection block of the secondary winding and in fluid communication with an interior of an induction coil operably connected to the connection block.

In another aspect, the present invention is a method of cooling a transformer assembly comprising a primary winding wrapped about a magnetic core, the magnetic core having a central aperture transversely therethrough, and a secondary winding passing through the central aperture and about an exterior of the magnetic core by sealing the transformer assembly within a sealed enclosure defining a fluid impermeable boundary about the transformer assembly, affixing an induction coil to a connection block electrically connected to the secondary winding, extending a terminal end of the primary winding through each of an enclosure inlet and an enclosure outlet disposed through the sealed enclosure, circulating cooling fluid through an transformer cooling circuit defined between the enclosure inlet and the enclosure outlet, such that cooling fluid directly contacts the magnetic core and the primary winding, and redirecting the cooling fluid flowing through the transformer cooling circuit to hot spots defined within the primary winding, the secondary winding, and the magnetic core via one or more deflecting surfaces within the sealed enclosure.

These and other aspects of the invention are set forth in this specification and the appended claims.

### BRIEF DESCRIPTION OF THE DRAWINGS

The foregoing brief summary, as well as the following detailed description of the invention, is better understood when read in conjunction with the appended drawings. For the purpose of illustrating the invention, there is shown in the drawings exemplary forms of the invention that are presently preferred; however, the invention is not limited to the specific arrangements and instrumentalities disclosed in the appended drawings.

FIG. 1(a) is a perspective view of one example of a submerged ferrite fluid cooled transformer of the present invention.

FIG. 1(b) is a perspective view of the submerged ferrite fluid cooled transformer of FIG. 1(a) with an upper shell portion of the sealed enclosure removed.

FIG. 2 is a front center cross-sectional elevation view of the submerged ferrite fluid cooled transformer shown in FIG. 1(a) along line 2-2 of FIG. 1(a).

FIG. 3 is a rear perspective view of the submerged ferrite fluid cooled transformer shown in FIG. 1(a).

FIG. 4 is an exploded view of the submerged ferrite fluid cooled transformer shown in FIG. 1(a).

FIG. 5(a) is a perspective view of the submerged ferrite fluid cooled transformer shown in FIG. 1(a) illustrating with arrows the cooling fluid flow path through the primary winding of the transformer assembly.

FIG. 5(b) is a perspective view of the submerged ferrite fluid cooled transformer shown in FIG. 1(a) illustrating with arrows the cooling fluid flow path through each of the sealed enclosure and secondary winding of the transformer assembly.

FIG. 6(a) is a perspective view of an alternate example of a submerged ferrite fluid cooled transformer of the present invention.

FIG. 6(b) is a perspective view of the submerged ferrite fluid cooled transformer of FIG. 6(a) with the sealed enclosure structure removed.

FIG. 7 is an exploded view of the submerged ferrite fluid cooled transformer of FIG. 6(a).

FIG. 8 is a front perspective view of the submerged ferrite fluid cooled transformer of FIG. 6(a).

FIG. 9 is a cross-sectional view of the submerged ferrite fluid cooled transformer shown in FIG. 6(a) along line 9-9 of FIG. 6(a).

FIG. 10(a) is a perspective view of an interior of the rear shell portion of the sealed enclosure of the transformer of FIG. 6(a) showing a first canalized cooling fluid path.

FIG. 10(b) is a perspective view of the transformer assembly of the submerged ferrite fluid cooled transformer of FIG. 6(a) showing the first canalized cooling fluid path.

FIG. 10(c) is a perspective view of an interior of the rear shell portion of the sealed enclosure of the transformer of FIG. 6(a) showing a second canalized cooling fluid path.

FIG. 10(d) is a perspective view of the transformer assembly of the submerged ferrite fluid cooled transformer of FIG. 6(a) showing the second canalized cooling fluid path.

FIG. 10(e) is a perspective view of an interior of the rear shell portion of the sealed enclosure of the transformer of FIG. 6(a) showing a third canalized cooling fluid path.

FIG. 10(f) is a perspective view of the transformer assembly of the submerged ferrite fluid cooled transformer of FIG. 6(a) showing the third canalized cooling fluid path.

FIG. 10(g) is a perspective view of an interior of the rear shell portion of the sealed enclosure of the transformer of FIG. 6(a) showing a fourth canalized cooling fluid path.

FIG. 10(h) is a perspective view of the transformer assembly of the submerged ferrite fluid cooled transformer of FIG. 6(a) showing the fourth canalized cooling fluid path.

FIG. 10(i) is a perspective view of an opposing side of an interior of the rear shell portion of the sealed enclosure of the transformer of FIG. 6(a).

### DETAILED DESCRIPTION OF THE INVENTION

There is shown in the drawings one example of a submerged ferrite flowing fluid cooled transformer of the present invention. For the purposes of this disclosure, the terms “ferrite,” “magnetic core,” and “powder core” are used interchangeably to refer to the magnetic core of the transformer assembly and should not be construed as necessarily limiting.

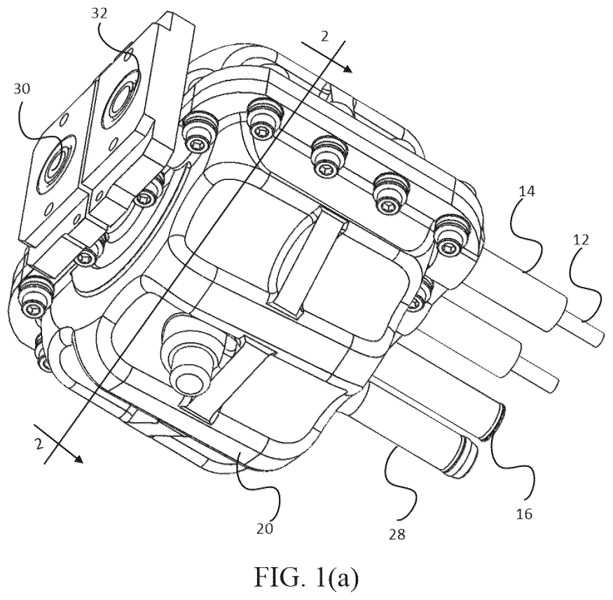

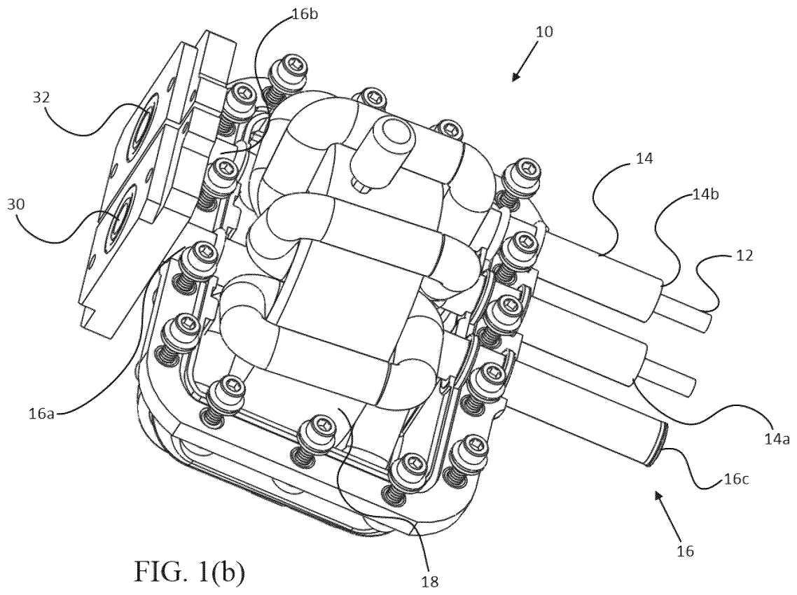

As shown in the drawings, the transformer assembly 10 comprises a primary winding 12 wrapped about a toroidal or other annularly shaped magnetic core 18 and a secondary winding 16 passing through a center of the magnetic core 18 and disposed about an exterior of the magnetic core 18. In some embodiments, the primary winding 12 comprises electrically insulated conductive wiring directly in contact with the magnetic core 18. In the shown embodiment of FIG. 1(a), the primary winding 12 is disposed within a flexible tubing 14, the flexible tubing 14 providing a pathway for a cooling fluid to flow to reduce heat buildup within the primary winding 12, thereby increasing the ampacity of the primary winding 12. In a preferred embodiment, the cooling fluid comprises water due to its increased thermal conductivity and reduced weight relative to alternate cooling fluids, such as oil, although other fluids having similar properties are also contemplated. The cooling fluid flows from a cooling fluid source through a primary winding inlet 14a to a primary winding outlet 14b. In one embodiment, the primary winding 12 comprise litz wire, whereupon application of convective cooling fluid flow, the ampacity of the litz wire increases up to four times the nominal ampacity of litz wire. The flexible tubing 14 further comprises an electrically insulative material, removing the requirement to electrically insulate the magnetic core 18.

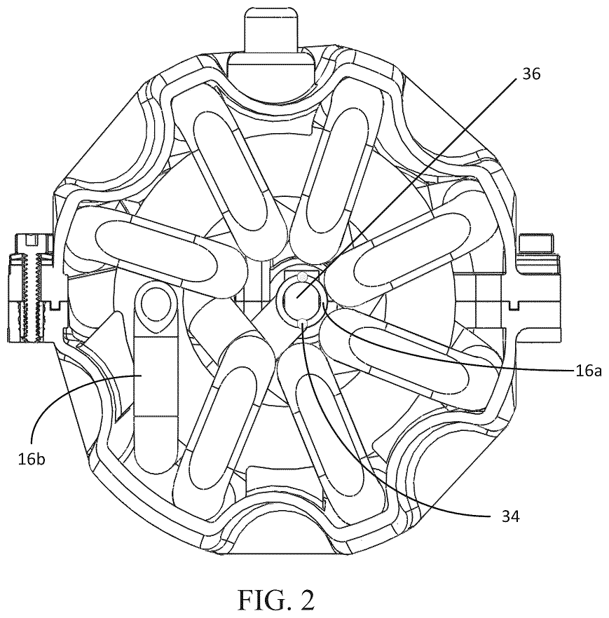

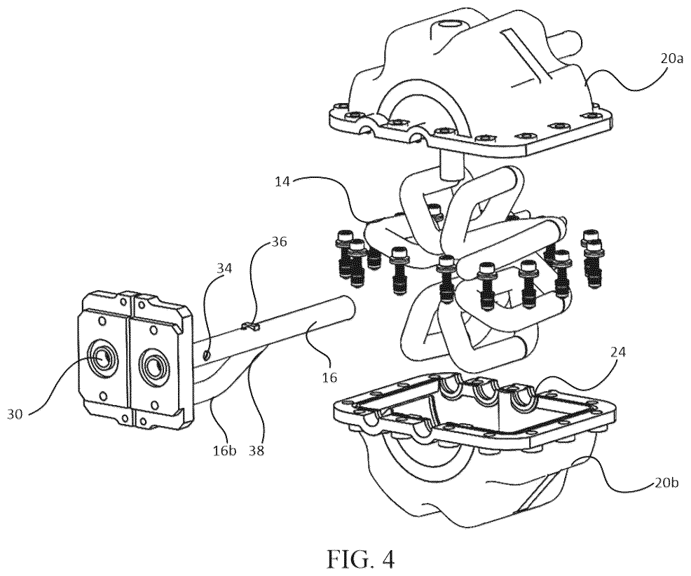

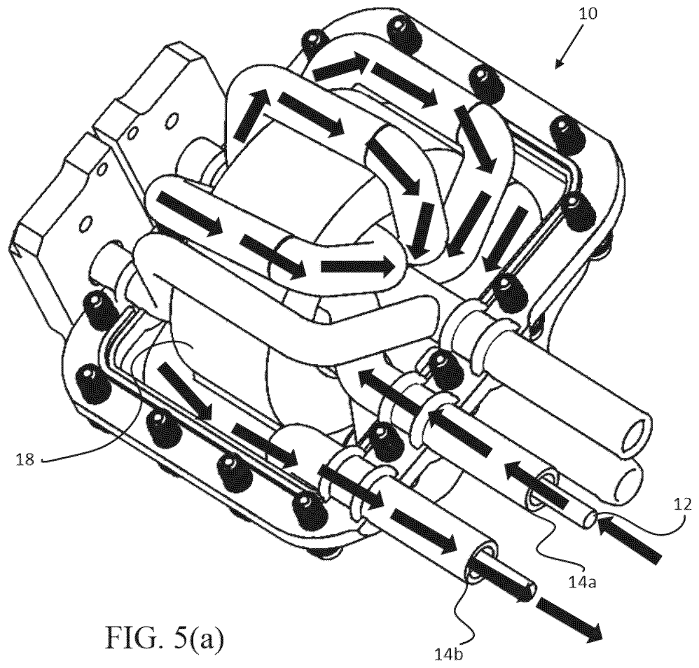

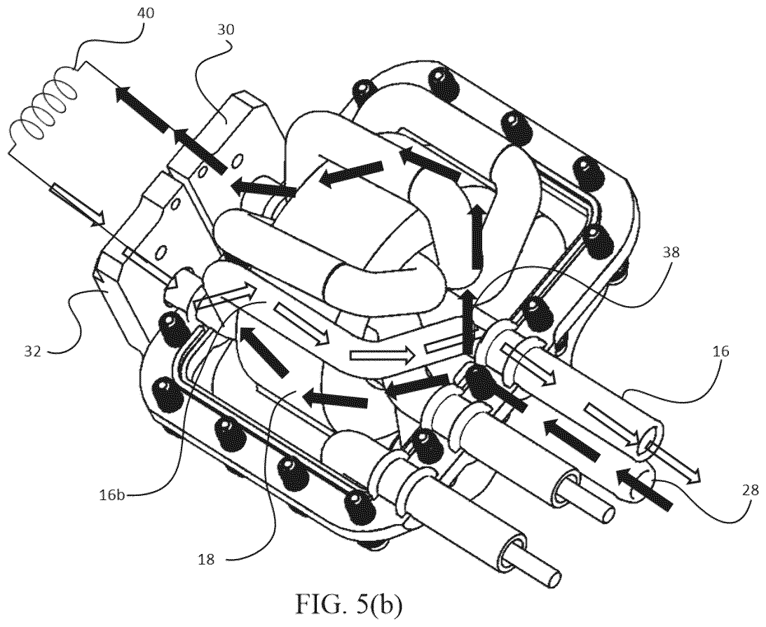

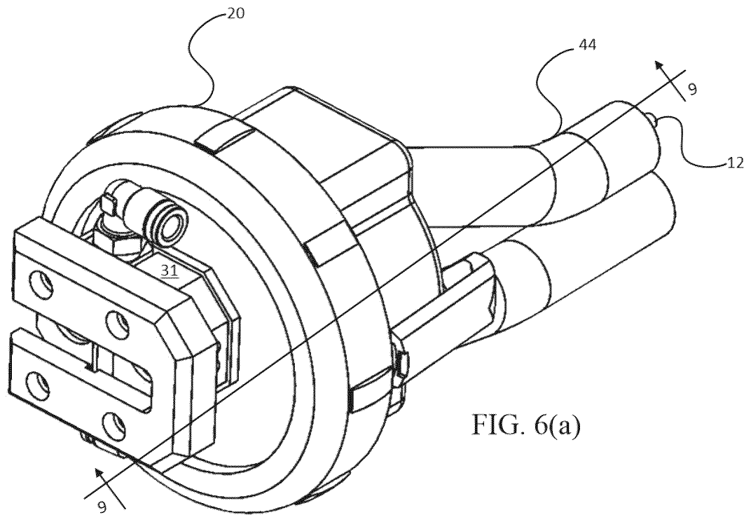

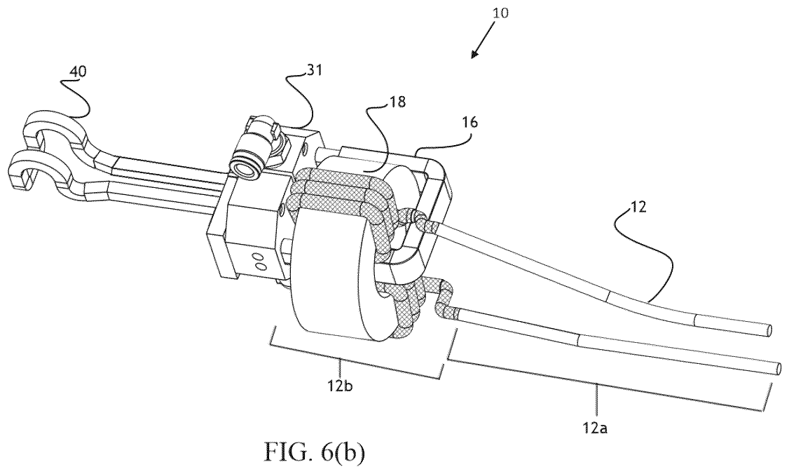

The secondary winding 16 comprises fluid-cooled tubing having the cooling fluid circulating therethrough. The secondary winding 16 includes a central line 16a passing through a center of the magnetic core 18 terminating at a connection block outlet 30, and a return line 16b extending from a connection block inlet 32 and passing about an exterior of the magnetic core 18 and rejoining the central line 16a at a junction point 38, as best illustrated in FIG. 4. As shown in FIGS. 2 and 4, a dam 36 is disposed across the interior of the central line 16a proximate to the junction point 38, such that fluid flowing from the return line 16b is diverted to a secondary winding outlet 16c. One or more ports 34 are disposed through the central line 16a between the dam 36 and the connection block outlet 30, the one or more ports 34 configured to receive cooling fluid from an interior volume of a scaled enclosure 20 disposed about the transformer assembly 10 as further described elsewhere herein. The enclosure cooling fluid is then transmitted through the connection block outlet 30 into an associated induction coil or heater (as illustrated in FIG. 5(b), 40) affixed to the connection block outlet and the connection block inlet 30, 32, such that the enclosure cooling fluid is shared with the induction coil or heater, thereby reducing the required number of fluid supply connections. Connection block inlet and connection block outlet 30, 32 define electrically isolated positive and negative terminals of a connection block (as illustrated in FIG. 6(a), 31) electrically connected to the secondary winding 16. In one embodiment, the secondary winding 16 comprises fluid-cooled copper tubing.

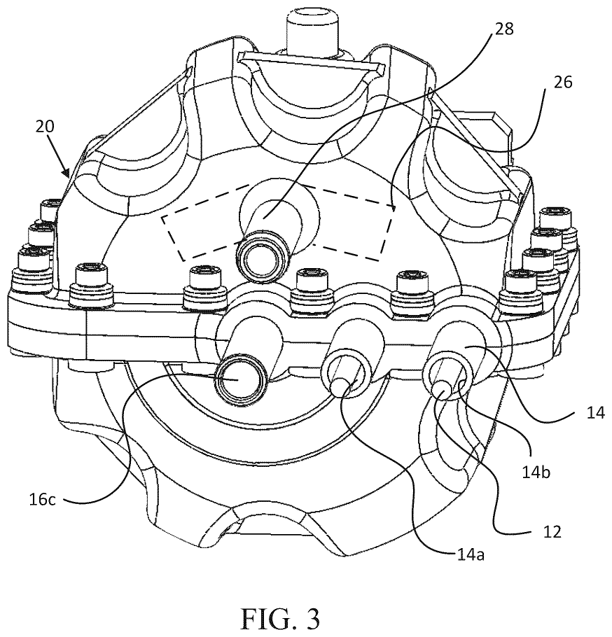

As shown in FIG. 1(b), the transformer assembly 10 is disposed within a sealed enclosure 20, the sealed enclosure 20 defining a liquid-tight interior volume. Referring now to FIG. 1(b) and FIG. 3, an opening is disposed through the sealed enclosure 20 for each of the primary winding inlet 14a, primary winding outlet 14b, secondary winding outlet 16c, connection block outlet 30, and connection block inlet 32. As best illustrated in FIG. 4, one or more gaskets 24 can be disposed about each of the inlets and outlets in order to ensure a liquid-tight seal. An enclosure inlet 28 is disposed through the sealed enclosure 20 and in fluid communication with the cooled fluid source, such that fluid is driven through the enclosure inlet 28 into the interior volume of the sealed enclosure 20. In one embodiment, at least one channel 26 is molded into the sealed enclosure 20 to divert fluid from the enclosure inlet 28 along one or more sidewalls of the sealed enclosure 20. Once the sealed enclosure 20 is filled with fluid, the magnetic core 18 is submerged in and in direct contact with flowing fluid across the entire exterior surface of the magnetic core 18, thereby increasing heat transfer from the magnetic core 18. As such, operative duty cycles of the transformer assembly 10 can be significantly extended while reducing thermal stresses on the magnetic core 18 in comparison to indirect cooling approaches. As shown in the drawings, connection block inlet 32 and connection block outlet 30 are disposed on a front side of the sealed enclosure 20, and the primary winding input 14a, primary winding output 14b, secondary winding outlet 16c, and enclosure inlet 28 are disposed on a rear side of the sealed enclosure 20, such that each inlet and outlet in communication with the cooling fluid source is in proximity to the cooling fluid source. The sealed enclosure 20 further comprises an upper shell portion 20a removably securable to a lower shell portion 20b via fasteners, adhesive, slip fit, press fit, or other mechanical engagement capable of forming a liquid-tight seal. As such, the interior volume is readily accessible for maintenance.

Due to the increased heat transfer capabilities of the present invention, magnetic cores with increased permeability and magnetic energy storage properties can be utilized in place of conventional ferrite cores of similar size and weight. For example, high flux powder cores provide substantially increased saturation flux density in comparison to conventional ferrite cores, resulting in a greater effective power delivery capacity. Typical high flux powder cores comprise a 50% nickel/50% iron alloy powder, producing saturation flux densities in the range of 15,000 gauss. As power output is increased over similar size and weight conventional ferrite cores and the weight of the transformer assembly 10 is reduced by eliminating conventional mechanical heat sink structures, the present invention provides a significant power to weight ratio increase over conventional ferrite cores and cooling methods.

In operation, as shown in FIGS. 5(a) and 5(b), cooling fluid from the cooling fluid source is delivered to the transformer assembly 10 and enters each of the primary winding inlet 14a and the enclosure inlet 28. The cooling fluid enters the sealed enclosure from the enclosure inlet 28, filling the interior volume and submerging the magnetic core 18. In one embodiment, the cooling fluid flow is diverted along the at least one channel, such that the cooling fluid enters the interior volume along one or more sidewalls of the sealed enclosure. Once the magnetic core 18 is submerged, the cooling fluid then is then driven into the secondary winding 16 through the ports prior to exiting through the connection block outlet 30 into an associated induction coil or heater cooling system 40 affixed to the connection blocks. Once the cooling fluid travels through the associated induction coil or heater cooling system 40, the cooling fluid is directed through the connection block inlet 32 to the return line 16b, through the junction point, diverted by the dam, and exiting through the secondary winding outlet 16c. Simultaneously, in the shown embodiment, cooling fluid from the cooling fluid source is introduced into the primary winding inlet 14a, such that the cooling fluid flows through the flexible tubing 14 about the primary winding 12. The cooling fluid is transmitted through each turn of the primary winding 12 about the magnetic core 18 and returns to the cooling fluid source via the primary winding outlet 14b disposed adjacent to the primary winding inlet 14a. In this manner, the magnetic core 18 and the primary winding 12 are simultaneously and independently cooled by flowing cooling fluid to efficiently transfer heat and improve performance of the transformer assembly 10.

Alternatively, in the illustrated embodiment of FIG. 6(a) through FIG. 10(i), the transformer comprises two independent and distinct cooling fluid circuits in parallel, a transformer assembly cooling circuit and a coil cooling circuit. As such, coil cooling efficiency is increased as the cooling fluid is not initially heated after passing over the magnetic core and through the secondary winding as in the previously discussed embodiment. Instead, the transformer cooling circuit and the coil cooling circuit may be separately connected to a common cooling fluid source, or alternatively be connected to two independent cooling fluid sources. In this manner, different cooling fluids, such as water, oil, or the like, may be utilized in each cooling circuit as necessary. Alternatively, distinct cooling fluid sources facilitate the use of cooling fluids having different initial operating conditions, such as initial temperatures or fluid pressures. As the overall volume of each cooling circuit is reduced in comparison to the previous embodiment shown in FIG. 1(a), required cooling fluid pressures necessary to produce the desired cooling effect across each circuit are significantly reduced. Furthermore, due to the reduced complexity of the cooling circuit in comparison to the prior embodiment, potential points of failure caused by fluid blockages are similarly reduced and a consistent laminar flow within the sealed enclosure 20 can be achieved, resulting in a reduced number of hot spots within the transformer components.

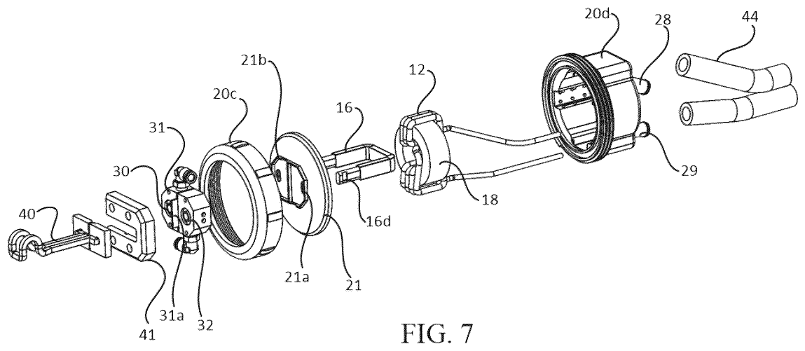

As shown in FIG. 6(b), the transformer assembly 10 comprises a primary winding 12 wound about a toroidal or other annularly shaped magnetic core 18 and a secondary winding 16 passing through the center of the magnetic core 18 and extending around an exterior of the magnetic core 18. The primary winding 12 is contemplated to comprise any suitable electrical conductor, such as litz wire. In the illustrated embodiment, the secondary winding 16 comprise a solid U-shaped copper winding having an inner leg extending through the center of the magnetic core 18 and an outer leg extending around an exterior of the magnetic core 18. In FIG. 6(b), the inner leg extends between the discrete partitions of the primary winding 12 disposed about opposing sides of the magnetic core 18, such that the flow of electrical energy within the secondary winding 16 is perpendicular to the flow of electrical energy within in the primary winding 12. This configuration produces a reduction in localized hot spots present within the magnetic core, as well as reduced transformer leakage inductance. Each leg of the secondary winding 16 terminates in a connection block 31 to conduct electrical energy from the secondary winding 16 through an induction coil or heater 40 affixed thereto. Connection block 31 further comprises an positive side electrically isolated from a negative side, wherein the connection block inlet (as shown in FIG. 7, 32) and the connection block outlet (as shown in FIG. 7, 30) each correspond to one of the positive side and the negative side. In contrast to the previous embodiment of FIG. 1(a), manufacturing difficulty of the solid secondary winding 16 of the present embodiment is significantly reduced, as no internal flow channels, ports, dams, or other features are required. As illustrated in FIG. 6(b) and FIG. 7, a distal end 16d of each leg of the secondary winding 16 decreases in diameter to interface with the connection block 31 and achieve a solid brazed connection therebetween. The secondary winding 16 further comprise a dielectric varnish on an exterior surface thereof, wherein the dielectric varnish provides dielectric insulation between the secondary winding 16, the magnetic core 18, the primary winding 12, and the cooling fluid circulating through the sealed enclosure.

As shown in FIG. 7, the primary winding 12 enters the sealed enclosure via openings defined through the enclosure inlet 28 and the enclosure outlet 29 and are further disposed within fluid lines 44 attached to the enclosure inlet 28 and the enclosure outlet 29. The primary winding 12 is further electrically insulated from the magnetic core 18 a dielectric material jacket, such as, but not limited to a high dielectric polyolefin plastic. For the purposes of this disclosure, the term “high dielectric” refers to dielectric strengths of at least 500 V/mil. In some embodiments, the dielectric material jacket further comprises heat-shrink tubing. In the illustrated embodiment of FIG. 6(a) and FIG. 6(b), the primary winding 12 comprises the dielectric material jacket along a partial length thereof, defining a bare section 12a and an insulated section 12b. The bare section 12a extends through the fluid lines 44 and the primary winding 12 transitions to the insulated section 12b upon entry to the scaled enclosure 20. In this manner, the dielectric material is limited to areas proximate to the magnetic core 18 to limit thermal insulation caused by the dielectric material, such that heat transfer efficiency from the primary winding 12 is maximized due to direct cooling fluid contact with the primary winding 12 within the fluid lines 44 along the bare section 12a.

As illustrated in FIG. 7, sealed enclosure comprises a front shell portion 20c removably affixed to a rear shell portion 20d, wherein the sealed enclosure defines a liquid-tight sealed interior volume. Contrary to the embodiment shown in FIG. 1(a), sealed enclosure 20 is retained together via threaded engagement between the front shell portion 20c and the rear shell portion 20d, wherein the threaded sections form a liquid-tight seal. Enclosure inlet 28 and enclosure outlet 29 extend from the rear shell portion 20d to receive fluid lines 44 thereon. The front shell portion 20c further comprises a cap 21, wherein the cap 21 further comprises a pair of cap openings 21a therethrough. In some embodiments, cap 21 is removably securable within the front shell portion 20c, however, front shell portions 20c having an integral cap 21 are also contemplated. The pair of cap openings 21a receive the distal ends 16d of each leg of the secondary winding 16 therethrough, wherein the secondary winding 16 and the pair of cap openings 21a are dimensioned to form a liquid tight seal when inserted therethrough. In some embodiments, a gasket, such as an O-ring, is partially seated within a perimeter pocket disposed about an interior of the pair of cap openings 21a to further establish a liquid tight seal to prevent cooling fluid from the interior of the sealed enclosure from passing through the pair of cap openings 21a in use. In the illustrated embodiment, cap 21 further comprises a lip 21b extending from an exterior surface thereof, wherein the lip 21b is dimensioned to seat connection block 31 therein. In some embodiments, lip 21b further comprises a central divider configured to seat within a channel defined between the positive side and the negative side of the connection block 31. Lip 21b seats the connection block 31 on cap 21 to align the pair of cap openings 21a with complementary connection points on the connection block 31, such that the secondary winding 16 can be operably secured thereto.

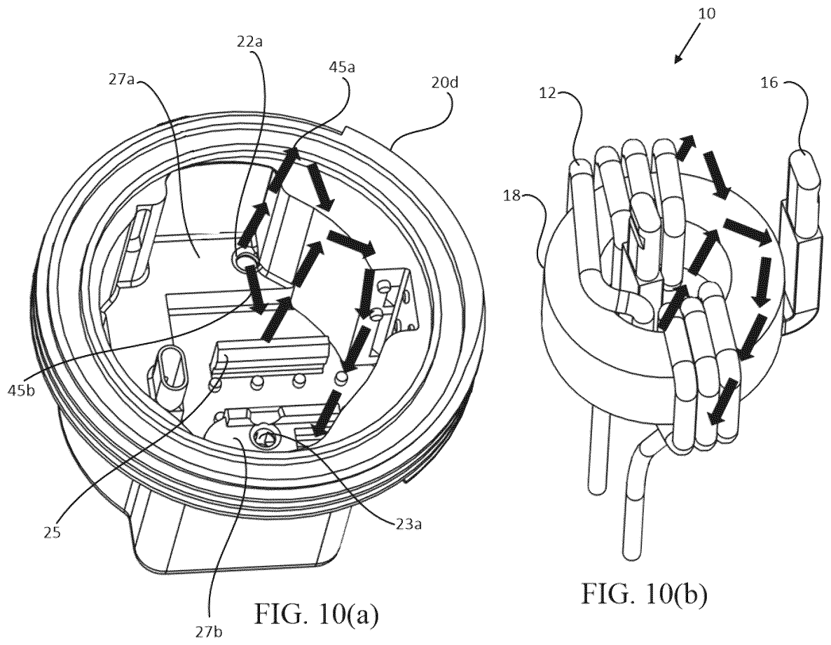

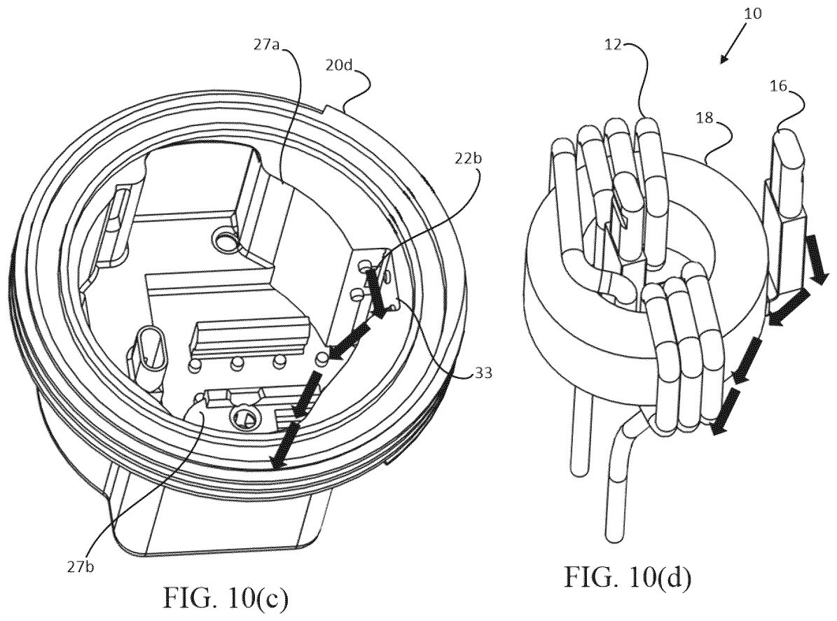

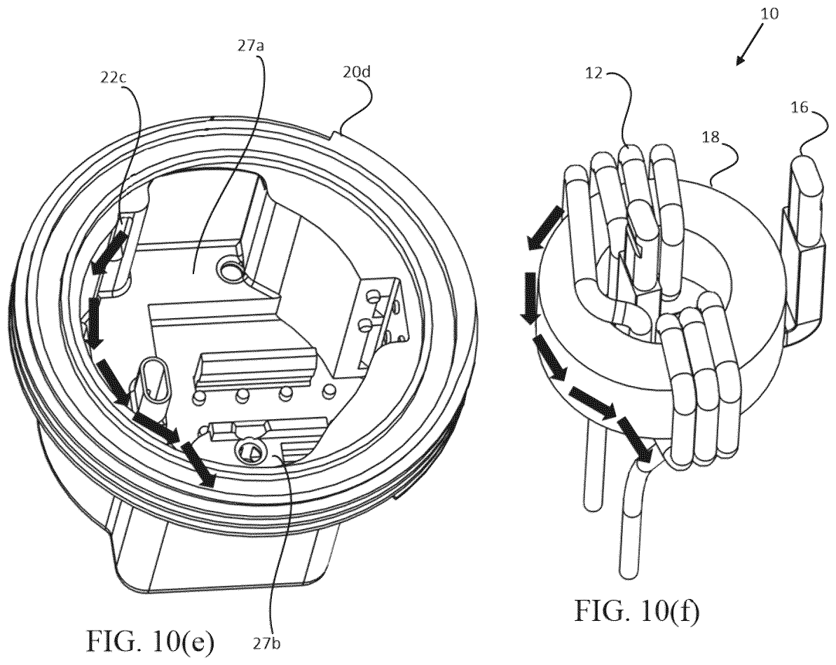

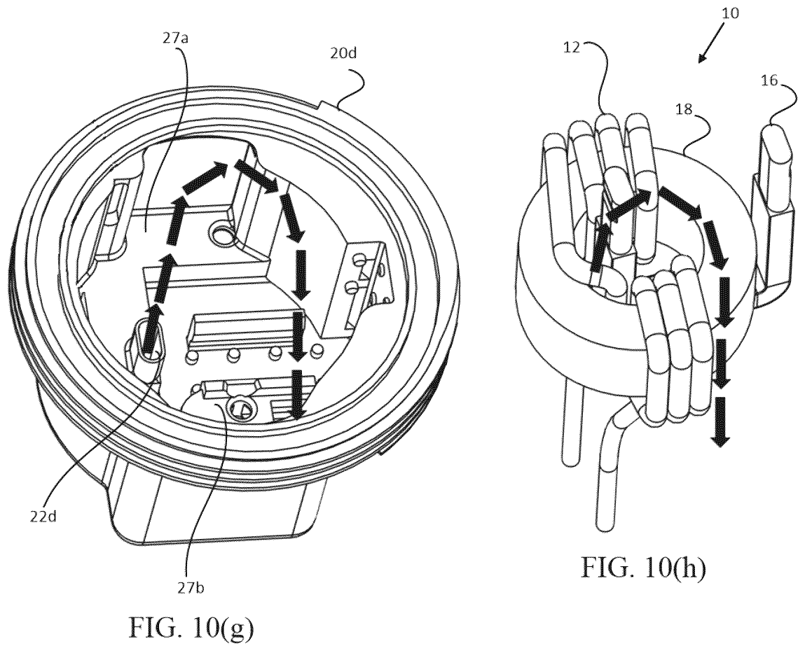

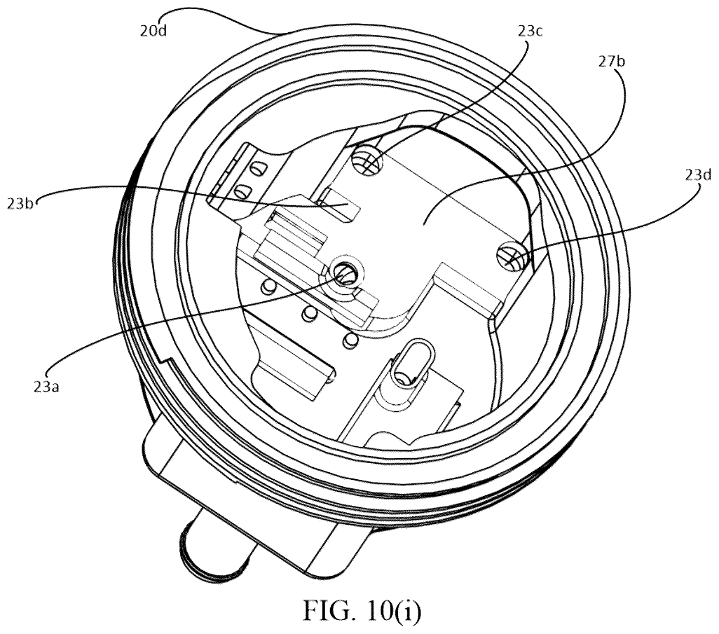

In the shown embodiment, the enclosure inlet 28 and the enclosure outlet 29 are offset from a central longitudinal axis of the sealed enclosure, such that the primary winding 12 curve through interior channels defined in the rear shell portion 20d to enter and exit the sealed enclosure via one of a plurality of distributed enclosure openings disposed through a sidewall of the interior channels. The interior channels are disposed along an interior of the rear shell portion 20d on opposing sides thereof to define an entrance interior channel associated with the enclosure inlet 28, and an exit interior channel associated with the enclosure outlet 29. As further described below in reference to FIGS. 10(a) through 10(i), the interior channels of the sealed enclosure direct cooling fluid to the plurality of distributed enclosure openings to define discrete separate canalized fluid flow patterns to directly address localized hot spots present on the primary winding 12, the secondary winding 16, and the magnetic core 18.

In the illustrated embodiment, induction coil 40 is affixed to the connection block 31 via retention plate 41 secured thereto. Retention plate 41 comprises a substantially U-shaped plate defining a central opening dimensioned to retain each terminal of the induction coil 40 between the connection block 31 and the retention plate 41. The induction coil 40 is operably connected to connection block 31 and in fluid communication with the connection block outlet 30 and the connection block inlet 32 such that cooling fluid from the coil cooling circuit travels through the interior of the induction coil 40. In the illustrated embodiment, a tab 31a extending from the connection block 31 passes between each terminal of the induction coil 40 and engages a complementary recess defined in a rear side of the retention plate 41. In some embodiments, the tab comprises a dielectric material to ensure electrical isolation between the terminals of the induction coil 40, as well as between each portion of the connection block 31. In this manner, induction coil 40 is properly aligned, seated on, and secured to connection block 31.

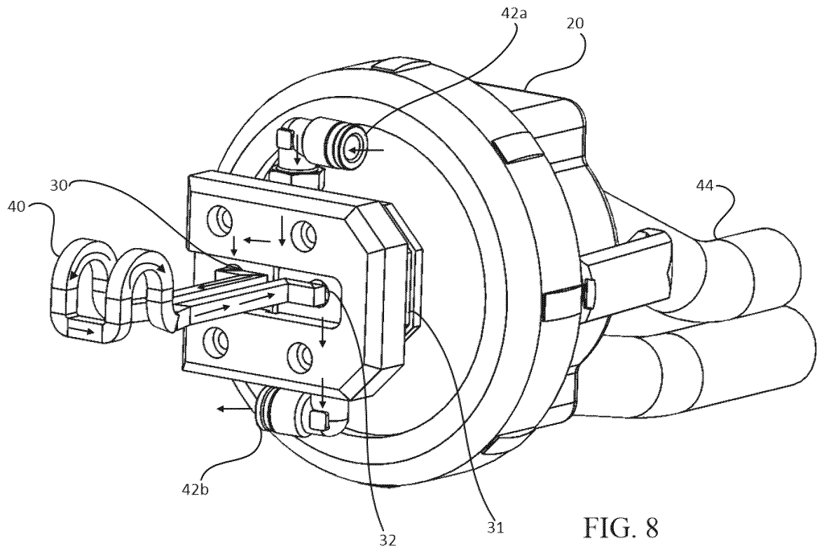

As illustrated in FIG. 8, the coil cooling circuit is defined between coil inlet 42a and coil outlet 42b, wherein cooling fluid entering through coil inlet 42a passes through an interior volume of coil 40 before exiting through coil outlet 42b. Coil inlet 42a and coil outlet 42b are affixed to connection block 31 exterior to the sealed enclosure 20 on opposing sides of the connection block 31. In the present embodiment, connection block 31 is operably connected to the secondary winding disposed within the sealed enclosure 20, however, in contrast to the embodiment of FIG. 1(a), connection block 31 is impermeable to fluid disposed within the sealed enclosure 20. Coil inlet 42a is in fluid communication with connection block outlet 30 and coil outlet 42b is in fluid communication with connection block inlet 32. In this manner, cooling fluid flows through coil inlet 42a into connection block 31 and further into coil 40 connected to connection block outlet 30, exiting coil 40 at connection block inlet 32 and further exiting the connection block 31 at coil outlet 42b. In the illustrated embodiment, coil inlet 42a and coil outlet 42b extend in opposing directions and further comprise connectors for receiving a coil fluid line thereon, wherein the connectors are contemplated to include friction fit or threaded connections.

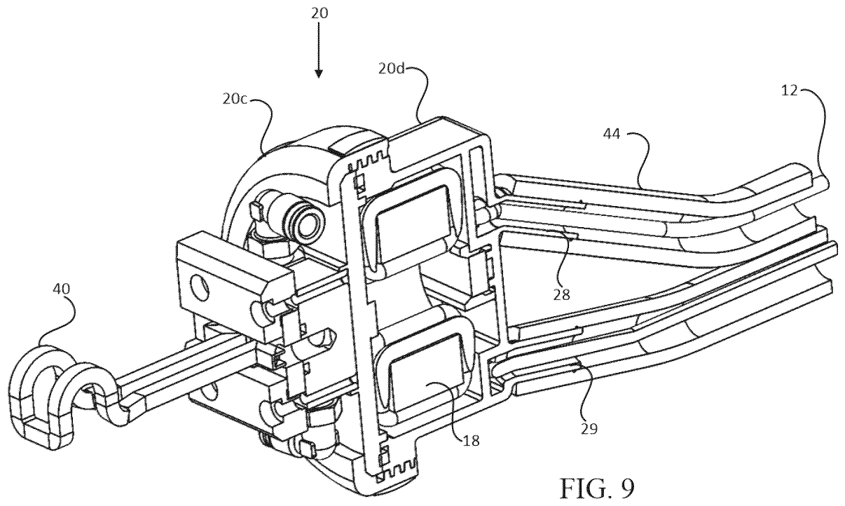

The transformer cooling circuit is defined between an enclosure inlet 28 and an enclosure outlet 29 as best illustrated in FIG. 9, wherein cooling fluid flows into the scaled enclosure 20 via the enclosure inlet 28 and circulates through the interior volume of the sealed enclosure 20 before exiting via enclosure outlet 29. Scaled enclosure 20 further comprises one or more internal deflecting surfaces configured to canalize cooling fluid flow through the sealed enclosure 20 to directly address areas of increased temperature (hot spots) within the primary winding 12, secondary winding 16, and magnetic core 18 as further described elsewhere herein. Cooling fluid is delivered to scaled enclosure 20 via fluid lines 44 affixed to the enclosure inlet 28 and the enclosure outlet 29, respectively. As best illustrated in FIG. 9, enclosure inlet 28 and enclosure outlet 29 extend from a rear side of the rear shell portion 20d defining tube fittings over which fluid lines 44 secure. In some embodiments, the fluid lines 44 secure to the enclosure inlet 28 and the enclosure outlet 29 via friction fit, however, threaded connections or other securement means are also contemplated. The flowrate of cooling fluid through enclosure inlet 28 and the enclosure outlet 29 at steady state operation is equivalent, such that cooling fluid fills an entirety of the interior volume of the sealed enclosure 20, however, the flowrates through each of the enclosure inlet 28 and the enclosure outlet 29 may be further adjusted for initial filling or eventual emptying of the sealed enclosure 20. In this manner, in operation, the primary winding 12, secondary winding, and the magnetic core 18 disposed within the sealed enclosure 20 are effectively submerged in a flowing cooling fluid to rapidly transfer heat therefrom. Primary winding 12 further extend coaxially through each of the enclosure inlet 28 and the enclosure outlet 29, as well as the associated fluid lines 44 affixed thereto, to operably connect to a power source.

As best illustrated in FIGS. 10(a) through 10(h), cooling fluid flow within the sealed enclosure is canalized into several discrete fluid flow pathways. The fluid flow pathways are directed with a focus towards areas of increased heat accumulation within the transformer assembly 10, such as the inner leg portions of the secondary winding 16 and the inner turn portions of the primary winding 12, wherein the inner turn portions and inner leg portions are defined within a central aperture of the magnetic core 18. Additionally, heat generation within the portion of the magnetic core 18 shared by the primary winding 12 and the secondary winding 16 is increased relative to the remainder of the magnetic core 18. As such, each individual fluid flow pathway is primarily optimized to address heat buildup within these areas. The rear shell portion 20d further comprises an entrance interior channel 27a in fluid communication with the enclosure inlet and an exit interior channel 27b in fluid communication with the enclosure outlet. A plurality of entrance enclosure openings (22a, 22b, 22c, 22d) are disposed through entrance interior channel 27a, such that each of the plurality of entrance enclosure openings are in fluid communication. Similarly, a plurality of exit enclosure openings (23a, 23b, 23c, 23d), as best illustrated in FIG. 10(i), are disposed through the exit interior channel 27b, such that each of the plurality of enclosure openings are in fluid communication.

As shown in FIGS. 10(a) and 10(b), a first fluid flow pathway is represented by flow arrows through each of the rear shell portion 20d and the transformer assembly 10, wherein the flow arrows of FIG. 10(a) provide an unobstructed view of the complete fluid flow pathway. However, it should be understood that, in operation, transformer assembly 10 is disposed within the rear shell portion 20d. In operation, primary winding 12 enters the sealed enclosure through the first entrance enclosure opening 22a. An opposing end of the primary winding 12 exits the sealed enclosure through the first exit enclosure opening 23a. In the illustrated embodiment, each of the first entrance enclosure opening 22a and the first exit enclosure opening 23a comprise a bevel about a perimeter thereof to reduce friction between the primary winding 12 and the respective enclosure openings. In some embodiments, a lip is formed on an edge of the exit interior channel 27b adjacent to the first exit enclosure opening 23a, wherein the lip further comprises a semi-circular relief therein, the relief dimensioned to receive the primary winding 12 therein. The combination of the beveled enclosure openings and the semi-circular relief eliminate sharp bends in the primary winding 12 which cause undue stress to the wire. The first fluid flow pathway enters scaled enclosure via a first entrance enclosure opening 22a disposed through the entrance interior channel 27a, wherein the first entrance enclosure opening 22a is substantially parallel to a base of the rear shell portion 20d. Cooling fluid is then diverted around the magnetic core 18 along substantially vertical and horizontal flow portions 45a, 45b relative to the base of the rear shell portion 20d. The vertical flow portion 45a is deflected across an upper surface of the magnetic core 18 via the cap of the sealed enclosure 20. The horizontal flow portion 45b is further deflected upwards through the central aperture of the magnetic core 18 via deflection barrier 25 extending from the base of the rear shell portion 20d perpendicular to the flow direction of the horizontal flow portion 45b. In this manner, the deflected horizontal flow portion 45b flows along a central leg of the secondary winding 16 before rejoining the vertical flow portion 45a to substantially surround one side of the magnetic core 18 and the primary winding 12 wrapped thereabout. Once through the central aperture of the magnetic core 18, the horizontal and vertical flow portions 45a. 45b rejoin and are directed over an opposing side of the magnetic core 18, whereupon the first fluid flow pathway exits the sealed enclosure via one of a plurality of exit enclosure openings disposed through an exit interior channel 27b. In some embodiments, the first fluid flow pathway is sufficiently canalized to exit substantially through a specific exit enclosure opening, such as the first exit enclosure opening 23a. In this manner, in operation, the first fluid flow pathway travels along an exterior of the primary winding 12 wrapped about opposing sides of the magnetic core 18, as well as through the center of the magnetic core 18.

Similarly, as shown in FIGS. 10(c) and 10(d), a second fluid flow pathway is represented by flow arrows through each of the rear shell portion 20d and the transformer assembly 10, wherein the flow arrows of FIG. 10(c) provide an unobstructed view of the complete fluid flow pathway. The second fluid flow pathway enters sealed enclosure via a second entrance enclosure opening 22b disposed through a lateral side of the entrance interior channel 27a. In the shown embodiment, the second entrance enclosure opening 22b comprises a rectangular opening, wherein the rectangle defined by the second entrance enclosure opening 22b comprises a longitudinal axis substantially perpendicular to the base of the rear shell portion 20d. The second entrance enclosure opening 22b is disposed within a recess 33 defined within an interior wall of the rear shell portion 20d, wherein the recess 33 is dimensioned to receive an outer leg of the secondary winding 16 therein. The second fluid flow pathway exits the second entrance enclosure opening 22b parallel to the base of the rear shell portion 20d and passes over an exterior surface of the outer leg of the secondary winding 16 and across an outer surface area of the magnetic core 18 along a circumference thereof prior to exiting the sealed enclosure via one of the plurality of exit enclosure openings disposed through the exit interior channel 27b. In some embodiments, the second fluid flow pathway is sufficiently canalized to exit substantially through a specific exit enclosure opening, such as the second exit enclosure opening 23b as shown in FIG. 10(i).

Additionally, as shown in FIGS. 10(c) and 10(f), a third fluid flow pathway is represented by flow arrows through each of the rear shell portion 20d and the transformer assembly 10, wherein the flow arrows of FIG. 10(c) provide an unobstructed view of the complete fluid flow pathway. The third fluid flow pathway enters sealed enclosure via a third entrance enclosure opening 22c disposed through a lateral side of the entrance interior channel 27a opposite the second entrance enclosure opening 22b. In the shown embodiment, the third entrance enclosure opening 22c comprises a rectangular opening, wherein the rectangular opening defined by the third entrance enclosure opening 22c comprises a longitudinal axis substantially perpendicular to the base of the rear shell portion 20d. The third fluid flow pathway exits the third entrance enclosure opening 22c parallel to the base of the rear shell portion 20d and passes over an exterior surface of the magnetic core 18 along a circumference thereof opposite the second fluid flow pathway prior to exiting the sealed enclosure via one of the plurality of exit enclosure openings disposed through the exit interior channel 27b. In some embodiments, the third fluid flow pathway is sufficiently canalized to exit substantially through a specific exit enclosure opening, such as the third exit enclosure opening 23c as shown in FIG. 10(i).

Finally, as shown in FIGS. 10(g) and 10(h), a fourth fluid flow pathway is represented by flow arrows through each of the rear shell portion 20d and the transformer assembly 10, wherein the flow arrows of FIG. 10(g) provide an unobstructed view of the complete fluid flow pathway. The fourth fluid flow pathway enters sealed enclosure via a fourth entrance enclosure opening 22d disposed through the entrance interior channel 27a approximately aligned with the recess 33 within which the outer leg of the secondary winding 16 resides. In the shown embodiment, the fourth entrance enclosure opening 22d comprises a rectangular opening, wherein the rectangular opening defined by the fourth entrance enclosure opening 22d comprises a longitudinal axis substantially parallel to the base of the rear shell portion 20d. A shroud extends perpendicularly from the entrance interior channel 27a, wherein the rectangular opening is defined through a distal end of the shroud. The fourth fluid flow pathway exits the fourth entrance enclosure opening 22d perpendicular to the base of the rear shell portion 20d and passes through the central aperture of the magnetic core 18 and over an exterior surface of an inner leg of the secondary winding 16 prior to exiting the sealed enclosure via one of the plurality of exit enclosure openings disposed through the exit interior channel 27b. In some embodiments, the fourth fluid flow pathway is sufficiently canalized to exit substantially through a specific exit enclosure opening, such as the fourth exit enclosure opening 23a as shown in FIG. 10(i).

In this manner, the combination of the first, second, third, and fourth fluid flow pathways direct cooling fluid over areas of increased heat accumulation in the transformer assembly 10, namely the areas of the primary winding 12 and the secondary winding 16 passing through the central aperture of the magnetic core 18, as well as the areas of the magnetic core 18 where the magnetic flux concentrates due to coupling between the magnetic core 18 and both the primary winding 12 and the secondary winding 16 simultaneously.

Reference throughout this specification to “one example or embodiment,” “an example or embodiment,” “one or more examples or embodiments,” or “different example or embodiments,” for example, means that a particular feature may be included in the practice of the invention. In the description various features are sometimes grouped together in a single example, embodiment, figure, or description thereof for the purpose of streamlining the disclosure and aiding in the understanding of various inventive aspects.

The present invention has been described in terms of preferred examples and embodiments. Equivalents, alternatives and modifications, aside from those expressly stated, are possible and within the scope of the invention. Those skilled in the art, having the benefit of the teachings of this specification, may make modifications thereto without departing from the scope of the invention.

1. A submerged ferrite flowing fluid cooled transformer, comprising:
a transformer assembly, comprising:
a magnetic core having a central aperture extending transversely through the magnetic core;
a primary winding wrapped about the magnetic core, the primary winding connected to an external power source;
wherein the primary winding comprises a bare section and an insulated section, the insulated section proximate to the magnetic core;
wherein the insulated section comprises a dielectric material jacket disposed over the primary winding;
a secondary winding having a solid interior construction, the secondary winding extending through the central aperture and about an exterior of the magnetic core;
wherein the secondary winding comprises a dielectric varnish on an exterior surface thereof;
a sealed enclosure comprising a front shell portion removably securable to a rear shell portion to form a fluid impermeable seal therebetween, wherein the sealed enclosure is dimensioned to receive the transformer assembly therein;
wherein the sealed enclosure further comprises an enclosure inlet and an enclosure outlet extending from a rear side of the rear shell portion;
a fluid line removably secured to each of the enclosure inlet and the enclosure outlet, wherein each end of the primary winding extends coaxially through each of the enclosure inlet and the associated fluid line and the enclosure outlet and the associated fluid line;
wherein the fluid lines are operably connected to an external cooling fluid source configured to circulate cooling fluid through the sealed enclosure defining a transformer cooling circuit;
a pair of cap openings disposed through a cap of the front shell portion, wherein each end of the secondary winding extends through one of the pair of cap openings to operably secure to opposing terminals of a connection block;
wherein the pair of cap openings form a fluid impermeable seal about each end of the secondary winding, such that cooling fluid within the sealed enclosure is retained therein.

2. The submerged ferrite flowing fluid cooled transformer of claim 1, wherein the magnetic core comprises a high flux powder core having a saturation flux density of approximately 15,000 gauss.

3. The submerged ferrite flowing fluid cooled transformer of claim 1, wherein the primary winding is disposed about the magnetic core in two discrete primary winding partitions, wherein the discrete primary winding partitions are disposed on opposing sides of the magnetic core.

4. The submerged ferrite flowing fluid cooled transformer of claim 1, wherein the secondary winding comprises a U-shaped structure having an inner leg extending through the central aperture of the magnetic core and an outer leg extending about an exterior of the magnetic core, wherein a distal end of each of the inner leg and the outer leg decreases in diameter to interface with the connection block.

5. The submerged ferrite flowing fluid cooled transformer of claim 1, further comprising a coil cooling circuit operably connected to a secondary external cooling fluid source configured to circulate cooling fluid through the coil cooling circuit, wherein the coil cooling circuit comprises:
a coil inlet disposed on a first terminal of the connection block, the coil inlet in fluid communication with a connection block outlet disposed through a front side of the first terminal;
a coil outlet disposed on a second terminal of the connection block, the coil outlet in fluid communication with a connection block inlet disposed through a front side of the second terminal;
an induction coil having a hollow interior channel therethrough, the induction coil electrically connected to the connection block and secured over each of the connection block inlet and the connection block outlet such that the hollow interior channel is in fluid communication therewith.

6. The submerged ferrite flowing fluid cooled transformer of claim 1, wherein the enclosure inlet is in fluid communication with an entrance interior channel disposed within the rear shell portion, the entrance interior channel having a plurality of entrance enclosure openings distributed thereacross, and wherein the enclosure outlet is in fluid communication with an exit interior channel disposed within the rear shell portion, the exit interior channel having a plurality of exit enclosure openings distributed thereacross.

7. The submerged ferrite flowing fluid cooled transformer of claim 6, further comprising a recess disposed on an interior of the rear shell portion, wherein the recess is disposed between the entrance interior channel and the exit interior channel, the recess dimensioned to receive the outer leg of the secondary winding therein.

8. The submerged ferrite flowing fluid cooled transformer of claim 7, further comprising a deflection barrier disposed along a base of the rear shell portion between the entrance interior channel and the exit interior channel, the deflection barrier configured to perpendicularly redirect fluid flow from at least one of the plurality of entrance enclosure openings.

9. The submerged ferrite flowing fluid cooled transformer of claim 8, wherein the plurality of entrance enclosure openings distributed across the entrance interior channel define a plurality of canalized cooling fluid flow pathways through the sealed enclosure, the plurality of canalized cooling fluid flow pathways comprising:
a first canalized cooling fluid flow pathway defined between a first entrance enclosure opening and at least one exit enclosure opening of the plurality of exit enclosure openings, wherein the first entrance enclosure opening is disposed on a central upper surface of the entrance interior channel;
wherein the first canalized cooling fluid flow pathway comprises a vertical flow portion perpendicular to the base of the rear shell portion, the vertical flow portion extending about an exterior of the magnetic core along an upper side thereof and a horizontal flow portion parallel to the base of the rear shell portion, the horizontal flow portion passing along the base of the rear shell portion, whereupon the horizontal flow portion is diverted through the central aperture of the magnetic core via the deflection barrier to rejoin the vertical flow portion to pass over an opposing side of the magnetic core;
a second canalized cooling fluid flow pathway defined between a second entrance enclosure opening and at least one exit enclosure opening of the plurality of exit enclosure openings, wherein the second entrance enclosure opening is disposed on a lateral side of the entrance interior channel within the recess;
wherein the second canalized cooling fluid flow pathway is directed parallel to the base of the rear shell portion over an exterior of the outer leg of the secondary winding and an exterior side of the magnetic core;
a third canalized cooling fluid flow pathway defined between a third entrance enclosure opening and at least one exit enclosure opening of the plurality of exit enclosure openings, wherein the third entrance enclosure opening is disposed on an opposing lateral side of the entrance interior channel;
wherein the third canalized cooling fluid flow pathway is directed parallel to the base of the rear shell portion over an exterior side of the magnetic core opposite the second canalized cooling fluid flow pathway;
a fourth canalized cooling fluid flow pathway defined between a fourth entrance enclosure opening and at least one exit enclosure opening of the plurality of exit enclosure openings, wherein the fourth entrance enclosure opening is disposed through the entrance interior channel opposite to and aligned with the recess;
wherein the fourth canalized cooling fluid flow pathway is directed perpendicular to the base of the rear shell portion through the central aperture of the magnetic core and over an upper side thereof.

10. The submerged ferrite flowing fluid cooled transformer of claim 1, further comprising a lip disposed on an exterior surface of the cap, the lip dimensioned to correspond to a perimeter of the connection block to seat the connection block therein.

11. The submerged ferrite flowing fluid cooled transformer of claim 10, wherein the lip further comprises a central divider configured to seat within a channel disposed between opposing terminals of the connection block.

12. The submerged ferrite flowing fluid cooled transformer of claim 1, further comprising a tab extending from the connection block, the tab comprising a dielectric material and configured to electrically isolate opposing terminals of an induction coil operably connected to the connection block.

13. The submerged ferrite fluid cooled transformer of claim 12, wherein the induction coil is secured to the connection block via a retention plate comprising a U-shaped plate defining a central opening having a diameter less than a diameter of the opposing terminals of the induction coil, wherein the tab seats within a complementary recess disposed within a rear surface of the retention plate.

14. A submerged ferrite fluid cooled transformer, comprising:
a transformer assembly, comprising:
a magnetic core having a central aperture extending transversely through the magnetic core;
a primary winding wrapped about the magnetic core, the primary winding coaxially disposed within flexible tubing comprising a dielectric material;
wherein the primary winding is connected to an external power source;
wherein the flexible tubing is connected to an external cooling fluid source configured to circulate cooling fluid through the flexible tubing defining a primary winding cooling circuit;
a secondary winding comprising a central line and a return line branching from a junction point, the central line extending through the central aperture of the magnetic core and the return line passing about an exterior of the magnetic core, wherein the central line and the return line terminate in a connection block;
wherein the secondary winding comprises a hollow tubing in fluid communication with a cooling fluid source;
wherein the connection block comprises a connection block outlet in fluid communication with the central line and a connection block inlet in fluid communication with the return line;
a dam disposed across the interior of the central line proximate to the junction point, the dam configured to prevent fluid flow between the return line and the central line;
one or more ports disposed through the central line between the connection block outlet and the dam;
a sealed enclosure comprising an upper shell portion securable to a lower shell portion, to form a fluid impermeable seal therebetween, wherein the sealed enclosure is dimensioned to receive the transformer assembly therein, such that the connection block is disposed exterior to the sealed enclosure;
a primary winding inlet and a primary winding outlet disposed through the sealed enclosure, the primary winding inlet and the primary winding outlet dimensioned to receive the primary winding and the flexible tubing therethrough to form a fluid impermeable seal;
a secondary winding outlet disposed through the sealed enclosure dimensioned to receive the secondary winding therethrough to form a fluid impermeable seal;
an enclosure inlet extending from the upper shell portion providing access to an interior of the sealed enclosure, the enclosure inlet in fluid communication with an external cooling fluid source;
wherein a transformer cooling circuit is defined between the enclosure inlet and the secondary winding outlet, wherein cooling fluid passes over the transformer assembly and into the central line via the one or more ports, exits the connection block outlet, passes through an induction coil affixed to the connection block, enters the connection block inlet, and exits via the secondary winding outlet.

15. The submerged ferrite fluid cooled transformer of claim 14, further comprising one or more enclosure channels molded into the sealed enclosure, the one or more enclosure channels in fluid communication with the enclosure inlet and extending perpendicular to the enclosure inlet along a sidewall of the sealed enclosure.

16. The submerged ferrite fluid cooled transformer of claim 14, wherein the magnetic core comprises a high flux powder core having a saturation flux density of approximately 15,000 gauss.

17. A method of cooling a transformer assembly disposed within a sealed enclosure, comprising:
providing a transformer assembly comprising a primary winding wrapped about a magnetic core, the magnetic core having a central aperture transversely therethrough, and a secondary winding passing through the central aperture and around an exterior of the magnetic core;
sealing the transformer assembly within a sealed enclosure defining a fluid impermeable boundary about the transformer assembly;
securing a fluid line to each of an enclosure inlet and an enclosure outlet disposed on the sealed enclosure, wherein opposing ends of the primary winding extend through the enclosure inlet and the enclosure outlet;
affixing an induction coil to a connection block electrically connected to the secondary winding;
supplying an alternating electrical current to the primary winding via an external power source, such that electrical energy is transferred to the secondary winding and associated connection block;
pumping cooling fluid from an external cooling fluid source through the enclosure inlet and into the sealed enclosure to submerge the transformer assembly;
removing the cooling fluid from the enclosure outlet, thereby circulating the cooling fluid through an interior volume of the sealed enclosure defining a transformer cooling circuit;
redirecting the cooling fluid flowing through the transformer cooling circuit to hot spots defined within the primary winding, secondary winding, and magnetic core via one or more deflecting surfaces within the sealed enclosure.

18. The method of claim 17, further comprising the step of directing cooling fluid through an interior of the induction coil via a connection block outlet and a connection block inlet, wherein the connection block outlet and connection block inlet are in fluid communication with the external cooling fluid source.

19. The method of claim 18, further comprising the step of directing the cooling fluid flowing through the transformer cooling circuit through an interior of the secondary winding via one or more ports disposed thereon, wherein the interior of the secondary winding is in fluid communication with the connection block outlet and the interior of the induction coil.

20. The method of claim 17, further comprising the step of supplying cooling fluid to flexible tubing disposed coaxially about the primary winding defining a primary winding cooling circuit.
